(19) United States
(12) Patent Application Publication
(10) Pub. No.: US 2007/0031538 A1
(43) Pub. Date: Feb. 8, 2007

(54) Liquid nutritional compositions containing n-3 polyunsaturated fatty acids

(76) Inventors: Gul Konuklar, New Albany, OH (US); Sherri Walker, Sunbury, OH (US)

Correspondence Address: ROSS PRODUCTS DIVISION OF ABBOTT LABORATORIES;DEPARTMENT 108140-DS/1, 625 CLEVELAND AVENUE, COLUMBUS, OH, 43215-1724, US

(21) Appl. No.: 11/485,651

(22) Filed: Jul. 13, 2006

Related U.S. Application Data
(60) Provisional application No. 60/699,016, filed on Jul. 13, 2005.

(51) Int. Cl. A23L 1/30

(52) U.S. Cl. 426/72

(57) ABSTRACT

Disclosed are liquid nutritional compositions comprising protein; carbohydrate; a lipid component having from about 0.1% to about 20% of an n-3 polyunsaturated fatty acid by weight of the liquid composition; from about 0.01% to about 5% by weight of an Ascorbic Acid Component having a Water Soluble Fraction and an Oil Soluble Fraction in a weight ratio of from about 1:20 to about 20:1; wherein the composition is an aqueous emulsion having a continuous aqueous phase and at least one discontinuous non-aqueous phase, and wherein the non-aqueous phase comprises non-aqueous particles having a mode of particle size distribution of at least about 0.7 μm, and wherein at least about 90% of the non-aqueous particles have a diameter of at least about 0.5 μm. The composition is substantially free of iron. The compositions provide enhanced oxidative stability, flavor, and aroma, which are especially useful for emulsion systems containing relatively high n-3 polyunsaturated fatty acid concentrations.

This application claims the benefit of U.S. Provisional Application No. 60/699,016 filed Jul. 13, 2005

The present invention relates to liquid nutritional compositions comprising n-3 polyunsaturated fatty acids and having improved oxidative stability, flavor and aroma.

### BACKGROUND OF THE INVENTION

Nutritional formulas today are well known for a variety of dietary or disease specific applications in infants, children and adults. These formulas most typically contain a balance of proteins, carbohydrates, lipids, vitamins, and minerals tailored to the specific needs of the intended user, and include product forms such as ready-to-drink liquids, reconstitutable powders, nutritional bars, and many other forms.

Many nutritional formulas also commonly contain a variety of polyunsaturated fatty acids (PUFA) as part of the lipid component of the overall nutrient system, examples of which include omega-3 (n-3) fatty acids such as alpha-linolenic acid (C18:3n-3), stearidonic acid (C18:4n-3), eicosapentaenoic acid (C20:5n-3), docosapentaenoic acid (C22:5n-3), and docosahexaenoic acid (C22:6n-3), and omega-6 (n-6) fatty acids such as linoleic acid (Cl8:2n-6), gamma-linolenic acid (C18:3n-6), eicosadienoic acid (C20:2n-6), arachidonic acid (C20:4n-6), and di-homo-gamma-linolenic acid (C20:3n-6). A growing body of evidence now suggest that diets containing sufficient amounts of certain long chain polyunsaturated fatty acids may be beneficial for maintaining overall health, and may also be helpful for treating or preventing a variety of human diseases or afflictions. Certain long chain polyunsaturated fatty acids have been shown to be beneficial in the prevention and/or management of cardiovascular disease, rheumatoid arthritis, depression, Alzheimer's, ulcers, cancer, hyperactivity, asthma, or other diseases or conditions responsive to anti-inflammatory effects.

These polyunsaturated fatty acids, however, tend to be more sensitive to oxidation than many other ingredients commonly found in nutritional formulas. Due to their chemical structure, exposure to heat and atmospheric levels of oxygen can cause a series of chemical reactions about their carbon-carbon double bonds resulting in free radical formation. These free radicals can continue to break down the polyunsaturated fatty acids in an auto-oxidative process, which results in the development of undesirable off-flavors and odors and the eventual degradation of the beneficial polyunsaturated fatty acids. These polyunsaturated fatty acids are especially susceptible to oxidation when subjected to elevated temperatures during processing or storage.

Oxidative stability has become especially challenging when formulating a nutritional liquid containing the relatively high concentrations of polyunsaturated fatty acids often needed to obtain a therapeutic response. Allowing even some oxidation in these products often results in a highly objectionable flavor and aroma, the characteristics of which are often described as fishy or otherwise having a rancid flavor or smell, depending upon the particular polyunsaturated fatty acid used in the formulation.

Methods of controlling the undesirable oxidation of polyunsaturated fatty acids in a nutritional product include processing or manufacturing controls to limit conditions such as elevated temperatures, exposure to ultraviolet light, and other factors that can promote oxidation. All such methods almost always include the concurrent formulation with one or more anti-oxidant additives such as ascorbic acid or ascorbyl palmitate, tocopherols, beta-carotene, as well as many others. Although these methods are often highly effective in reducing much of the undesirable oxidation that would otherwise occur, they are often not as effective when applied to liquid nutritional compositions that contain the relatively high n-3 polyunsaturated fatty acid concentrations, e.g., high fish oil concentrations, often needed to achieve a desired therapeutic effect.

It has now been found, however, that liquid nutritionals containing relatively high n-3 polyunsaturated fatty acids can now be formulated with improved oxidative stability, without the need to reduce fatty acid concentrations in order to achieve the desired oxidative stability. This has been achieved by formulating a liquid nutritional composition with a protein component; a carbohydrate component; a lipid component having from about 0.1% to about 20% of an n-3 polyunsaturated fatty acid by weight of the liquid composition; from about 0.001% to about 9% by weight of an ascorbic acid component having a water soluble fraction and an oil soluble fraction in a weight ratio of from about 1:20 to about 20:1; wherein the composition is an aqueous emulsion having at least one discontinuous non-aqueous phase, wherein the non-aqueous phase comprises non-aqueous particles having a mode of particle size distribution of at least about 0.7 μm, and wherein at least about 90% of the non-aqueous particles have a diameter of at least about 0.5 μm. The composition is substantially free of iron.

It has been found that these liquid nutritional compositions provide enhanced oxidative stability, flavor, and aroma, which are especially useful for liquid nutritional emulsion systems containing relatively high n-3 polyunsaturated fatty acid concentrations, provided that the ascorbic acid component as defined herein is formulated in an iron-free matrix, all within an aqueous emulsion having a selected particle size distribution or characterization as also defined herein.

It is therefore an object of the present invention to provide a liquid nutritional composition containing relatively high concentrations of n-3 polyunsaturated fatty acids, wherein the composition has improved oxidative stability, flavor, and aroma, especially during prolonged storage. It is a further object of the present invention to provide such a composition without the need to reduce polyunsaturated fatty acid concentrations. It is a further object of the present invention to provide such a formulation in the form of an aqueous oil-in-water emulsion.

These and other objects of the present invention are described and shall be apparent from the description as set forth hereinafter.

### SUMMARY OF THE INVENTION

The present invention is directed to liquid nutritional comprising a protein component; a carbohydrate component; a lipid component having from about 0.1% to about 20% of an n-3 polyunsaturated fatty acid by weight of the liquid composition; from about 0.001% to about 9% by weight of an ascorbic acid component having a water soluble fraction and an oil soluble fraction in a weight ratio of from about 1:20 to about 20:1; wherein the liquid nutritional composition is substantially free of iron and is in the form of an aqueous emulsion having a continuous aqueous phase and at least one discontinuous non-aqueous phase, and wherein the non-aqueous phase comprises non-aqueous particles having a mode of particle size distribution of at least about 0.7 μm and wherein at least about 90% of the non-aqueous particles have a diameter of at least about 0.5 μm.

It has been found that liquid nutritionals that contain relatively high concentrations n-3 polyunsaturated fatty acids can be formulated with improved oxidative stability, flavor, and aroma, provided that the composition is an aqueous emulsion having a defined ascorbic acid component comprising a water soluble fraction and an oil soluble fraction in the relative weight ratios described herein, and provided that the select ratios are prepared in a liquid matrix that is substantially free of iron, and provided that the liquid matrix is an aqueous emulsion having a continuous aqueous phase and at least one discontinuous non-aqueous phase, and wherein the non-aqueous phase comprises non-aqueous particles having a mode of particle size distribution of at least about 0.7 μm and wherein at least about 90% of the non-aqueous particles have a diameter of at least about 0.5 μm.

It has also been found that product performance may be further enhanced by the addition of a tocopherol compound, the removal or omission of substantially all copper in the composition, or combinations thereof. These liquid nutritional compositions are especially effective in maintaining oxidative stability and minimizing the development of off flavors and aroma during prolonged storage.

### DETAILED DESCRIPTION OF THE INVENTION

The liquid nutritional compositions of the present invention are directed to aqueous liquid emulsions that comprise as essential ingredients protein, carbohydrate, and a lipid component containing an n-3 polyunsaturated fatty acid. Other essential features include a defined ascorbic acid component, a defined aqueous emulsion system, and a limitation on iron content. These and other essential or optional elements or limitations of the compositions of the present invention are described in detail hereinafter.

The term “lipid” as used herein, unless otherwise specified, means fats, oils, and combinations thereof.

The terms “polyunsaturated fatty acid” or “PUFA” as used herein, unless otherwise specified, refer to any polyunsaturated fatty acid or source thereof, including short chain (less than about 6 carbon atoms per chain), medium chain (from about 6 to 18 carbon atoms per chain) and long chain (having at least about 20 carbon atoms per chain) fatty acids having two or more carbon-carbon double bonds.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, 5, 6, from 1 to 9, from 3.6 to 4.6, from 3.5 to 9.9, and so forth.

Any reference to singular characteristics or limitations of the present invention shall include the corresponding plural characteristic or limitation, and vice versa, unless otherwise specified or clearly implied to the contrary by the context in which the reference is made.

Any combination of method or process steps as used herein may be performed in any order, unless otherwise specified or clearly implied to the contrary by the context in which the referenced combination is made.

The compositions of the present invention may comprise, consist of, or consist essentially of the essential elements and limitations of the invention described herein, as well as any additional or optional ingredients, components, or limitations described herein or otherwise useful in a nutritional application.

### Emulsion Particle Characteristics

The liquid nutritional compositions of the present invention must be in the form of an aqueous emulsion comprising a continuous aqueous phase and at least one discontinuous non-aqueous phase, wherein the non-aqueous phase has a defined particle size distribution or characterization as defined hereinafter.

The non-aqueous phase of the emulsion generally comprises the lipid component as described herein, as well as any other ingredients such as the water-insoluble fraction of the ascorbic acid component that more readily partition away from the aqueous phase and into or toward the non-aqueous phase. Many of the ingredients in the composition may partition into both phases of the emulsion system, rather than entirely into just one particular phase.

To provide the desired product performance as described herein, the discontinuous non-aqueous phase of the composition is formulated to have a mode of particle size distribution of at least about 0.7 μm, preferably from about 1.0 μm to about 4.0 μm, including from about 1.3 μm to about 3.7 am, wherein at least about 90% of the non-aqueous particles have a diameter of at least about 0.5 μm.

The above-described aqueous emulsion may be further characterized in terms of the resulting specific surface area of the discontinuous non-aqueous phase therein, such that the specific surface area is not more than about 80,000 cm² per gram of non-aqueous particles, preferably less than about 50,000 cm² per gram, including from about 10,000 cm² per gram to about 40,000 cm² per gram.

### Macronutrients

The liquid nutritional compositions of the present invention also comprise as essential ingredients protein, lipid, and carbohydrate. Many different sources and types of proteins, lipids, and carbohydrates are known and can be used in the various nutritional products described herein, provided that the selected nutrients are safe and effective for oral administration and are compatible with the essential and other added ingredients.

The concentration and relative amount of carbohydrate, protein, and carbohydrate in the liquid nutritional compositions can vary considerably depending upon the particular formulation desired, various product characteristics such as taste, flavor, stability, and so forth, as well as the specific dietary needs of the targeted user. Such concentrations and relative amounts as formulated into the liquid nutritional compositions of the present invention are preferably within the ranges described in the following table.

TABLE 1

| | Embodiments¹ | | |
|---|---|---|---|
| Macronutrient | A | B | C |
| Carbohydrate - % total calories | 10-70 | 20-60 | 40-60 |
| Lipid² - % total calories | 10-65 | 10-50 | 15-35 |
| Protein- % total calories | 5-40 | 10-30 | 15-25 |
| Carbohydrate g/100 ml | 1-40 | 4-30 | 10-20 |
| Lipid² g/100 ml | 0.1-30 | 0.5-15 | 1-5 |
| Protein g/100 ml | 0.5-30 | 1-15 | 2-10 |

¹Each numerical value is preceded by the term “about”
²Lipid includes n-3 polyunsaturated fatty acid

Carbohydrates suitable for use in the liquid nutritional compositions may be simple, complex, or variations or combinations thereof. Non-limiting examples of suitable carbohydrates include hydrolyzed or modified starch or cornstarch, maltodextrin, glucose polymers, sucrose, corn syrup, corn syrup solids, rice-derived carbohydrate, glucose, fructose, lactose, high fructose corn syrup, indigestible oligosaccharides (e.g., fructooligosaccharides), honey, sugar alcohols (e.g., maltitol, erythritol, sorbitol), and combinations thereof.

Carbohydrates suitable for use herein also include soluble dietary fiber, non-limiting examples of which include gum arabic, sodium carboxymethyl cellulose, guar gum, citrus pectin, low and high methoxy pectin, oat and barley glucans, carrageenan, psyllium and combinations thereof. Soluble dietary fiber is also suitable as a carbohydrate source herein, non-limiting examples of which include oat hull fiber, pea hull fiber, soy hull fiber, soy cotyledon fiber, sugar beet fiber, cellulose, corn bran, and combinations thereof.

Proteins suitable for use in the liquid nutritional products include hydrolyzed, partially hydrolyzed or non-hydrolyzed proteins or protein sources, and can be derived from any known or otherwise suitable source such as milk (e.g., casein, whey), animal (e.g., meat, fish), cereal (e.g., rice, corn), vegetable (e.g., soy), or combinations thereof. The proteins for use herein can also include, or be entirely or partially replaced by, free amino acids known for use in nutritional products, non-limiting examples of which include tryptophan, glutamine, tyrosine, methionine, cysteine, arginine, and combinations thereof.

The lipids suitable for use in the nutritional products must include the n-3 polyunsaturated fatty acid component as described herein, and may further comprise other lipids or lipid sources in addition to the n-3 polyunsaturated fatty acid component such as coconut oil, fractionated coconut oil, soy oil, corn oil, olive oil, safflower oil, high oleic safflower oil, MCT oil (medium chain triglycerides), sunflower oil, high oleic sunflower oil, palm and palm kernel oils, palm olein, canola oil, marine oils, cottonseed oils, and combinations thereof.

### Polyunsaturated Fatty Acid

The liquid nutritional compositions of the present invention comprise an n-3 polyunsaturated fatty acid as part of the lipid component described hereinbefore. The source of n-3 polyunsaturated fatty acid can be any known or otherwise suitable source that is safe and effective for oral administration and is compatible with the essential and other ingredients in the selected product formulation.

The n-3 polyunsaturated fatty acid concentration in the liquid nutritionals may vary depending upon many different factors such as the particular fatty acid selected, product form (e.g., sole source or supplemental nutrition), targeted user population (e.g., infants, children, diabetics, healthy adults), and the desired therapeutic outcome for the liquid nutrition (e.g., asthma care, cardiovascular health, infant nutrition, women's health).

Generally, however, such concentrations may represent a relatively high percentage of the finished product at up to about 20% by weight of the composition, including from about 0.1% to about 15%, including from about 0.5% to about 10%, including from about 1.0% to about 9%, including from about 2% to about 8%, including from about 3% to about 6%, and also including from about 3.5% to about 5%, all by weight of the composition.

Non-limiting examples of n-3 polyunsaturated fatty acids suitable for use herein include alpha-linolenic acid (ALA, C18:3n-3), stearidonic acid (C18:4n-3), eicosapentaenoic acid (EPA, C20:5n-3), docosapentaenoic acid (C22:5n-3), docosahexaenoic acid (DHA, C22:6n-3), and combinations thereof. Preferred are docosahexaenoic acid, eicosapentaenoic acid, and combinations thereof.

Non-limiting examples of sources of n-3 polyunsaturated fatty acids for use herein include flax seed oil, canola oil, transgenic oils, and fish oil. Non-limiting examples of fish oil sources include saltwater or cold fresh water fish, including albacore, black bass, bluefish, carp, menhaden oil, anchovy oil, pilchard oil, channel catfish, herring, lake herring, sardines, lake trout, mackerel, pompano, salmon, tuna, and white fish. Fish oil sources are preferred for use herein.

Other polyunsaturated fatty acids suitable for use in combination with the n-3 polyunsaturated fatty acid include any other polyunsaturated fatty acid suitable for use in a nutritional product, including the n-6 polyunsaturated fatty acids, non-limiting examples of which include linoleic acid (C18:2n-6), gamma-linolenic acid (GLA, C18:3n-6), eicosadienoic acid (C20:2n-6), arachidonic acid (ARA, C20:4n-6), di-homo-gamma-linolenic acid (DGLA, C20:3n-6), and combinations thereof. Non-limiting examples of suitable n-6 fatty acid sources for optional use herein include evening primrose oil, borage oil, black currant seed oil, flaxseed oil, transgenic sources, purified fatty acid sources, and combinations thereof.

The lipid component of the liquid nutritional composition may further comprise, in addition to the essential polyunsaturated fatty acid components as described above, any other lipid nutrient suitable for use in an oral nutritional product, non-limiting examples of which are described hereinbefore.

### Ascorbic Acid Component

The liquid nutritional compositions of the present invention comprise an ascorbic acid component defined by a water soluble fraction and an oil soluble fraction in a weight ratio of from about 1:20 to about 20:1, preferably from about 1:10 to about 10:1, more preferably from about 1:5 to about 5:1, including from about 1:3 to about 3:1, and also including from about 1:1 to about 2.5:1.

The concentration of the ascorbic acid component, which is the combination of the water soluble and oil soluble fractions therein, in the liquid nutritional composition ranges from about 0.001% to about 9%, preferably from about 0.005% to about 6%, including from about 0.01% to about 4%, also including from about 0.02% to about 1.0%, by weight of the composition.

The term “ascorbic acid component” as used herein, unless otherwise specified, means the combination of a water-soluble fraction and an oil soluble fraction, wherein each fraction is characterized in accordance with the definitions set forth herein. The “water soluble fraction” as used herein, unless otherwise specified, refers to ascorbic acid, salts thereof, or any derivative thereof that is at least 50% soluble in sterile water at 100° C., whereas the “oil soluble fraction” refers to those ascorbic acid derivatives or structurally similar materials that are not at least 50% soluble in sterile water at 100° C. Non-limiting examples of oil soluble fractions include ascorbyl palmitate, ascorbyl stearate, ascorbyl laureate, ascorbyl myristate, ascorbyl dipalmitate, ascorbyl tripalmitate, ascorbyl tetrapalmitate, or other ascorbic acid esters or derivatives suitable for use in a nutritional product formulation. The ascorbic acid component for use in the liquid nutritional composition of the present invention preferably comprises ascorbic acid and ascorbyl palmitate. Ascorbyl palmitate is available from a variety of suppliers and manufacturers, including Ascorbyl Palmitate NF, FCC, available from Hoffman-LaRoche, Inc. Ascorbic acid is likewise available from a variety of suppliers and manufacturers.

Although it has been found that the weight ratio of fractions defining the ascorbic acid component of the present invention is essential for achieving the product performance as described herein, it has also been found that this particular combination of ascorbic acid fractions is not sufficiently effective unless the product matrix is formulated to be substantially free of iron, preferably substantially free of unbound iron, as described hereinafter.

### Iron

The liquid nutritional compositions of the present invention, especially the ascorbic acid component thereof, must also be substantially free of iron. In this context, the term “substantially free” means that the liquid nutritional compositions contain less than about 0.5 mg of iron, preferably less than 0.3 mg of iron, including less than 0.2 mg of iron, and also including less than 0.05 mg of iron, and also including zero mg of iron, per each 100 ml of the liquid composition.

It has also been found that product performance as defined herein, especially that aspect of performance provided by the ascorbic acid component, is not acceptable unless the product matrix is formulated to be substantially free of iron. It has been found that unbound iron is especially detrimental to product performance when used in combination with the ascorbic acid component in the liquid composition, so that the composition is also preferably free of iron, especially unbound or free iron. If the composition contains any amount of iron, however, it is preferably bound or otherwise undissociated in the liquid composition.

The liquid nutritional compositions are also preferably substantially free of copper, especially unbound or free copper. In this context, the term “substantially free” means that the liquid compositions preferably contain less than about 0.5 mg of copper, preferably less than about 0.3 mg of copper, including less than about 0.05 mg of copper, and also including zero mg of copper, per each 100 ml of the liquid composition. If the compositions contain any amount of copper, it is preferably bound or otherwise undissociated in the liquid composition.

### Tocopherols

The liquid nutritional compositions of the present invention may further comprise a tocopherol or similar other ingredient derivative thereof. The source of tocopherol may be any known or otherwise suitable source that is safe and effective for oral administration and is compatible with the essential and other ingredients in the selected product formulation.

Tocopherol concentrations in the liquid compositions preferably range up to about 1%, preferably from about 0.005% to about 0.5%, including from about 0.04% to about 0.15%, by weight of the composition.

Tocopherols suitable for use in the liquid nutritional compositions may be natural or synthetic, and includes alpha tocopherol, beta tocopherol, gamma tocopherol, delta tocopherol, and combinations. Tocopherols for use herein include any methyl tocol compound, some characterizations of which are described in the following table.

TABLE 2

AOAC¹

| Trivial Name | Name | Designated Name |
|---|---|---|
| α-tocopherol | 5,7,8-trimethyltocol | — |
| d-α-tocopherol | 2R,4′R,8′R-α- | RRR-α-tocopherol |
| | tocopherol | |
| l-α-tocopherol | 2S,4′R,8′R-α- | 2-Epi-α-tocopherol |
| | tocopherol | |
| d,l-α-tocopherol | 2DL,4′DL,8′DL-α- | All-rac-α-tocopherol |
| (totally synthetic) | tocopherol | |
| d,l-α-tocopherol | — | 2-Ambo-α-tocopherol |
| (synthesis from | | |
| natural phytol) | | |
| β-tocopherol | — | 5,8-Dimethyltocol |
| γ-tocopherol | — | 7,8-Dimethyltocol |
| δ-tocopherol | — | 8-Methyltocol |
| Tocotrienol | 2-Methyl-2- | — |
| | (4′,8′,12′- | |
| | trimethylthrideca- | |
| | 3′,7′,11′- | |
| | tnenyl)ehroman-6-ol | |

¹Association of Official Analytical Chemists current through March 1997 Supplement

The term “tocopherol” as used herein, unless otherwise specified, preferably includes tocotrienols as well as tocopherols as conventionally defined. Tocotrienols structurally similar to tocopherols and can also be characterized as having an alpha, beta, gamma delta configuration. The tocotrienol structure differs from conventional tocopherols by possessing three double bonds in their side chain rather than being saturated.

Synthetic tocopherols for use herein include any of a variety of known tocopherols and derivatives thereof, including tocopherol acetate.

### Other Optional Ingredients

The liquid nutritional compositions of the present invention may further comprise other optional components that may modify the physical, chemical, aesthetic or processing characteristics of the products or serve as pharmaceutical or additional nutritional components when used in the targeted population. Many such optional ingredients are known or otherwise suitable for use in other nutritional products and may also be used in the compositions herein, provided that such optional ingredients are safe and effective for oral administration and are compatible with the essential and other ingredients in the selected product form.

Non-limiting examples of other optional ingredients include preservatives, emulsifying agents, buffers, additional antioxidants, pharmaceutical actives, sweeteners including artificial sweeteners (e.g., saccharine, aspartame, acesulfame K, sucralose) colorants, flavors, thickening agents and stabilizers, emulsifying agents, and so forth.

The liquid nutritional compositions of the present invention may further comprise vitamins or related nutrients, non-limiting examples of which include vitamin A, vitamin D, vitamin K, thiamine, riboflavin, pyridoxine, vitamin B₁₂, carotenoids (e.g., beta-carotene, zeaxanthin, lutein, lycopene), niacin, folic acid, pantothenic acid, biotin, choline, inositol, salts and derivatives thereof, and combinations thereof.

The liquid nutritional compositions may further comprise minerals, non-limiting examples of which include calcium, phosphorus, magnesium, zinc, manganese, sodium, potassium, molybdenum, chromium, chloride, and combinations thereof.

### Manufacture

The liquid nutritional compositions of the present invention may be prepared by any known or otherwise effective manufacturing technique for preparing a liquid nutritional formulation. Many such techniques are known in the nutrition and formulation arts and can easily be applied by one of ordinary skill in the art to the liquid nutritional compositions described herein.

### EXAMPLES

The following examples illustrate specific embodiments of the liquid nutritional compositions of the present invention, including a suitable technique to prepare the compositions. The examples are given solely for the purpose of illustration and are not to be construed as limitations of the present invention, as many variations thereof are possible without departing from the spirit and scope of the invention.

Examples 1-15 illustrate nutritional liquid embodiments of the present invention. Also included are corresponding methods of using the compositions. The ingredients for each exemplified composition are described in the following table. All ingredient amounts are listed as kg per 1000 kg batch of product, unless otherwise specified.

Each embodiment is prepared in accordance with the description described hereinafter in the form of an aqueous suspension having a continuous aqueous phase and at least one discontinuous non-aqueous phase, wherein the mode of particle size distribution of the non-aqueous particles is at least about 0.7 μm, most typically from 1.3 μm to 3.7 μm and at least about 90% of the non-aqueous particles have a diameter of at least about 0.5 μm. Each of non-aqueous particles in the various embodiments also has a specific surface area of 10,000-80,000 cm² per gram of the non-aqueous particles.

Ingredient Table: Examples 1-5

| Ingredient | Example 1 | Example 2 | Example 3 | Example 4 | Example 5 |
|---|---|---|---|---|---|
| Corn maltodextrin | 118.18 | 118.18 | 118.18 | 118.18 | 118.18 |
| Sodium caseinate | 34.19 | 34.19 | 34.19 | 34.19 | 34.19 |
| Milk protein isolate MPI | 31.37 | 31.37 | 31.37 | 31.37 | 31.37 |
| Sucrose | 26.39 | 26.39 | 26.39 | 26.39 | 26.39 |
| Corn syrup | 16.93 | 16.93 | 16.93 | 16.93 | 16.93 |
| Sardine oil¹ | 3.00 | 15.35 | 30.00 | 60.00 | 150.00 |
| Fructooligosaccharides | 13.16 | 13.16 | 13.16 | 13.16 | 13.16 |
| Calcium caseinate | 9.337 | 9.337 | 9.337 | 9.337 | 9.337 |
| Fractionated coconut oil | 5.686 | 5.686 | 5.686 | 5.686 | 5.686 |
| Flavor | 4.10 | 4.10 | 4.10 | 4.10 | 4.10 |
| Sodium citrate | 3.378 | 3.378 | 3.378 | 3.378 | 3.378 |
| Potassium citrate | 3.372 | 3.372 | 3.372 | 3.372 | 3.372 |
| Canola oil | 3.265 | 3.265 | 3.265 | 3.265 | 3.265 |
| Magnesium chloride | 2.678 | 2.678 | 2.678 | 2.678 | 2.678 |
| Micronized Tricalcium | 2.183 | 2.183 | 2.183 | 2.183 | 2.183 |
| phosphate | | | | | |
| Soybean oil | 1.932 | 1.932 | 1.932 | 1.932 | 1.932 |
| Lecithin | 1.380 | 1.380 | 1.380 | 1.380 | 1.380 |
| Mg phosphate dibasic | 0.5860 | 0.5860 | 0.5860 | 0.5860 | 0.5860 |
| Choline chlorine | 0.5511 | 0.5511 | 0.5511 | 0.5511 | 0.5511 |
| 45% NaOH solution | 0.2862 | 0.2862 | 0.2862 | 0.2862 | 0.2862 |
| Ascorbic acid | 0.2650 | 0.2650 | 0.2650 | 0.2650 | 0.2650 |
| Taurine | 0.2646 | 0.2646 | 0.2646 | 0.2646 | 0.2646 |
| Water soluble vitamins³ | 0.2510 | 0.2510 | 0.2510 | 0.2510 | 0.2510 |
| Potassium chloride | 0.1596 | 0.1596 | 0.1596 | 0.1596 | 0.1596 |
| L-carnitine | 0.1500 | 0.1500 | 0.1500 | 0.1500 | 0.1500 |
| UTM/TM Premix² | 0.1317 | 0.1317 | 0.1317 | 0.1317 | 0.1317 |
| Vitamins D, E, K⁴ | 00956 | 00956 | 00956 | 00956 | 00956 |
| Ascorbyl palmitate | 0.064 | 0.064 | 0.064 | 0.064 | 0.064 |
| Carrageenan⁵ | 0.0611 | 0.0611 | 0.0611 | 0.0611 | 0.0611 |
| Vit A palmitate | 0.165 | 0.165 | 0.165 | 0.165 | 0.165 |
| Tocopherol-2 antioxidant | 0.011 | 0.011 | 0.011 | 0.011 | 0.011 |
| (mixed tocopherols) | | | | | |
| Potassium Iodide | 0.0002 | 0.0002 | 0.0002 | 0.0002 | 0.0002 |
| Water | QS | QS | QS | QS | QS |

Ingredient Table: Examples 6-10

| Ingredient | Example 6 | Example 7 | Example 8 | Example 9 | Example 10 |
|---|---|---|---|---|---|
| Water | Q.S. | Q.S. | Q.S. | Q.S. | Q.S. |
| Corn maltodextrin | 118.18 | 118.18 | 118.18 | 118.18 | 118.18 |
| Sodium caseinate | 34.19 | 34.19 | 34.19 | 34.19 | 34.19 |
| Milk protein isolate MPI | 31.37 | 31.37 | 31.37 | 31.37 | 31.37 |
| Sucrose | 26.39 | 26.39 | 26.39 | 26.39 | 26.39 |
| Corn syrup | 16.93 | 16.93 | 16.93 | 16.93 | 16.93 |
| Sardine oil¹ | 3.00 | 15.35 | 30.00 | 60.00 | 15.35 |
| Fructooligosaccharides | 13.16 | 13.16 | 13.16 | 13.16 | 13.16 |
| Calcium caseinate | 9.337 | 9.337 | 9.337 | 9.337 | 9.337 |
| Fractionated coconut oil | 5.686 | 5.686 | 5.686 | 5.686 | 5.686 |
| Flavor | 4.10 | 4.10 | 4.10 | 4.10 | 4.10 |
| Sodium citrate | 3.378 | 3.378 | 3.378 | 3.378 | 3.378 |
| Potassium citrate | 3.372 | 3.372 | 3.372 | 3.372 | 3.372 |
| Canola oil | 3.265 | 3.265 | 3.265 | 3.265 | 3.265 |
| Magnesium chloride | 2.678 | 2.678 | 2.678 | 2.678 | 2.678 |
| Micronized Tricalcium | 2.183 | 2.183 | 2.183 | 2.183 | 2.183 |
| phosphate | | | | | |
| Soybean oil | 1.932 | 1.932 | 1.932 | 1.932 | 1.932 |
| Lecithin | 1.380 | 1.380 | 1.380 | 1.380 | 1.380 |
| Mg phosphate dibasic | 0.5860 | 0.5860 | 0.5860 | 0.5860 | 0.5860 |
| Choline chlorine | 0.5511 | 0.5511 | 0.5511 | 0.5511 | 0.5511 |
| 45% NaOH solution | 0.2862 | 0.2862 | 0.2862 | 0.2862 | 0.2862 |
| Ascorbic acid | 1.2800 | 0.6400 | 0.2650 | 0.2650 | 0.2650 |
| Taurine | 0.2646 | 0.2646 | 0.2646 | 0.2646 | 0.2646 |
| Water soluble vitamins³ | 0.2510 | 0.2510 | 0.2510 | 0.2510 | 0.2510 |
| Potassium chloride | 0.1596 | 0.1596 | 0.1596 | 0.1596 | 0.1596 |
| L-carnitine | 0.1500 | 0.1500 | 0.1500 | 0.1500 | 0.1500 |
| UTM/TM Premix² | 0.1317 | 0.1317 | 0.1317 | 0.1317 | 0.1317 |
| Vitamins D, E, K⁴ | 00956 | 00956 | 00956 | 00956 | 00956 |
| Ascorbyl palmitate | 0.064 | 0.064 | 0.064 | 2.646 | 1.323 |
| Carrageenan⁵ | 0.0611 | 0.0611 | 0.0611 | 0.0611 | 0.0611 |
| Vit A palmitate | 0.165 | 0.165 | 0.165 | 0.165 | 0.165 |
| Tocopherol-2 antioxidant | 0.011 | 0.011 | 0.011 | 0.011 | 0.011 |
| (mixed tocopherols) | | | | | |
| Potassium Iodide | 0.0002 | 0.0002 | 0.0002 | 0.0002 | 0.0002 |

¹Sardine oil contains 40% N-3 fatty acids (28% EPA and 12% DHA)- ingredient amounts listed as kg
of fish oil
²Ultra Trace Minerals/Trace Mineral Premix
³Niacinamide, D-calcium pantothenate, folic acid, thiamine chloride HCL, riboflavin, pyridoxine HCL,
cyanocobalamin, biotin
⁴dl - alpha tocopheryl, phylloquinone, vitamin D3
⁵Viscarin SA-359 (0.0459 kg) + Seakem CM-514 (0.0.152 kg)

Ingredient Table: Examples 11-15 (Chocolate system)

| Ingredient | Example 11 | Example 12 | Example 13 | Example 14 | Example 15 |
|---|---|---|---|---|---|
| Corn maltodextrin | 118.18 | 118.18 | 118.18 | 118.18 | 118.18 |
| Na caseinate | 43.53 | 34.19 | 34.19 | 34.19 | 34.19 |
| Milk protein isolate | 31.37 | 31.37 | 31.37 | 31.37 | 31.37 |
| Sucrose | 26.39 | 26.39 | 26.39 | 26.39 | 26.39 |
| Corn syrup | 16.93 | 16.93 | 16.93 | 16.93 | 16.93 |
| Sardine oil¹ | 15.35 | 15.35 | 30.00 | 60.00 | 150.00 |
| Fructooligosaccharides | 13.16 | 13.16 | 13.16 | 13.16 | 13.16 |
| Ca caseinate | 9.337 | 9.337 | 9.337 | 9.337 | 9.337 |
| Cocoa powder | 8.000 | 8.000 | 8.000 | 8.000 | 8.000 |
| Fractionated coconut oil | 5.686 | 5.686 | 5.686 | 5.686 | 5.686 |
| Sodium citrate | 3.378 | 3.378 | 3.378 | 3.378 | 3.378 |
| Potassium citrate | 3.372 | 3.372 | 3.372 | 3.372 | 3.372 |
| Canola oil | 3.265 | 3.265 | 3.265 | 3.265 | 3.265 |
| Magnesium chloride | 2.678 | 2.678 | 2.678 | 2.678 | 2.678 |
| Micronized tricalcium | 2.183 | 2.183 | 2.183 | 2.183 | 2.183 |
| phosphate | | | | | |
| Flavor | | 1.4 | | | |
| Soybean oil | 1.932 | 1.932 | 1.932 | 1.932 | 1.932 |
| Lecithin | 1.380 | 1.380 | 1.380 | 1.380 | 1.380 |
| Mg phosphate dibasic | 0.5860 | 0.5860 | 0.5860 | 0.5860 | 0.5860 |
| Choline chlorine | 0.5511 | 0.5511 | 0.5511 | 0.5511 | 0.5511 |
| 45% NaOH solution | 0.2862 | 0.2862 | 0.2862 | 0.2862 | 0.2862 |
| Ascorbic acid | 1.2800 | 0.6400 | 0.2650 | 0.2650 | 0.2650 |
| Taurine | 0.2646 | 0.2646 | 0.2646 | 0.2646 | 0.2646 |
| Water soluble vitamins³ | 0.2510 | 0.2510 | 0.2510 | 0.2510 | 0.2510 |
| Potassium chloride | 0.1596 | 0.1596 | 0.1596 | 0.1596 | 0.1596 |
| L-carnitine | 0.1500 | 0.1500 | 0.1500 | 0.1500 | 0.1500 |
| UTM/TM Premix² | 0.1317 | 0.1317 | 0.1317 | 0.1317 | 0.1317 |
| Vitamins D, E, K⁴ | 00956 | 00956 | 00956 | 00956 | 00956 |
| Ascorbyl palmitate | 0.064 | 0.064 | 0.064 | 0.064 | 0.064 |
| Carrageenan⁵ | 0.0611 | 0.0611 | 0.0611 | 0.0611 | 0.0611 |
| Vit A palmitate | 0.064 | 0.064 | 0.064 | 2.646 | 1.323 |
| Tocopherol-2 antioxidant | 0.08011 | 0.011 | 0.011 | 0.011 | 0.011 |
| (mixed tocopherols) | | | | | |
| Potassium Iodide | 0.0002 | 0.0002 | 0.0002 | 0.0002 | 0.0002 |
| Water | QS | QS | QS | QS | QS |

²Sardine oil contains 40% N-3 fatty acids (28% EPA and 12% DHA)- ingredient amounts listed as kg
of fish oil
²Ultra Trace Minerals/Trace Mineral Premix
³Niacinamide, D-calcium pantothenate, folic acid, thiamine chloride HCL, riboflavin, pyridoxine HCL,
cyanocobalamin, biotin
⁴dl - alpha tocopheryl (0.08011 kg), phylloquinone, vitamin D3
⁵Viscarin SA-359 (0.0459 kg) + Seakem CM-514 (0.0.152 kg)

The liquid nutritional embodiments of the present invention, including each of the exemplified formulas described above, may be prepared by forming at least three separate slurries, which are then blended together, heat-treated, and standardized. The resulting composition is then flavored, filled into 8 oz. cans, and sterilized.

For example, many of these formulas can be prepared by first formulating a carbohydrate-mineral slurry by adding an appropriate amount of potassium citrate and UTM/TM Premix to water at 140-160° with high agitation until the added ingredients are completely dissolved, and thereafter add (in order) magnesium chloride, potassium chloride, sodium citrate, potassium iodide, magnesium phosphate, and then M-TCP. Allow the resulting slurry to mix under moderate agitation until completely dissolved or dispersed. Then add Lodex 15, sucrose, and corn syrup to the mineral slurry with agitation. And then add FOS to the slurry and mix under high agitation until also completely dispersed. The slurry is recirculated to re-disperse any fallout particles. The resulting carbohydrate-mineral slurry is held under moderate agitation at 140-150° F. for a period of time not to exceed 8 hours until later combined with other ingredient during the manufacturing process.

A protein-in-water slurry is then prepared by adding to water at 140° F. in a blend tank calcium caseinate, sodium caseinate and MPI using a Silverson Mixer in a blend tank. After the ingredients have been added, the powder valve on the tank is closed to reduce foaming. The resulting protein-in-water slurry is agitated for 15 minutes to ensure complete dispersion. The slurry is held under agitation at 130-150° F. for not more than 2.5 hours until later combined with other ingredients during the manufacturing process.

A protein-in-fat slurry is then prepared by adding soy oil, MCT Oil, and canola oil to a kettle and heating the combination to 110-120° F. under moderate agitation. The Vitamin DEK premix is then added and completely dispersed with agitation, and thereafter soy lecithin, vitamin A, ascorbyl palmitate, and then Tenox GT2 (in that order) are also added with agitation to the developing slurry.

Viscarin SA-359 and Seakem CM514 are then added with agitation until completely dispersed. The resulting protein-in-fat slurry is then maintained with moderate agitation at 110-120° F. and held for not longer than 1 hour before adding to other ingredients during the manufacturing process.

The protein-in-fat slurry is then added to the protein in water slurry. The formed slurry is allowed to mix under moderate agitation for at least 5 minutes before adding to it the carbohydrate-mineral slurry. The resulting blend is allowed to mix under moderate agitation for at least 5 minutes.

The pH of the blend is measured, and if necessary, adjusted to a pH 6.5-6.8 using 1 N KOH solution.

Marine oil is then added to the pH-adjusted blend. The blend is subjected to moderate agitation for about 5 minutes. The blend should be processed within 10 minutes of adding the marine oil. The resulting blend is then heated to 160-180° F. using a plate or coil heater. It is then emulsified at 900-1100 psig in a single stage homogenizer and thereafter subjected to Ultra High Temperature (UHT) treatment (preheat to 210-230° F., heat mix to 290-297° F. and hold for 5 seconds, cool mix to 210-230° F., and then cool mix further to 150-170 OF). The UHT treated composition is homogenized at 160-170° F. at 3900-4100/400-600 psig. The homogenized blend is then passed through a holding tube and maintained at 160-180° F. for 16 seconds. The resulting blend is cooled, standardized, and stored at 34-45 ° F. Batch corrections and water addition can then be directed to the cooled formulation.

A vitamin solution is prepared by adding (with agitation) to water at 110-120° F. ascorbic acid, potassium hydroxide solution (45%), choline chloride, taurine, carnitine, and WSV Premix (water soluble vitamin premix). The resulting vitamin solution is maintained under low agitation and held not longer than 1 hour. The vitamin solution is added at the appropriate time to each batch formula.

A flavor solution is also prepared by adding the desired flavor components with agitation to water. Once completely dissolved, the resulting flavor solution is added to each batch at the appropriate time.

All batches are formulated with a pH of from 6.6 to 6.80. Adjustments are made if necessary using a 1 N KOH solution. The resulting manufactured composition is filled in an appropriate container, e.g., 8 oz. cans, and sterilized.

Each of the exemplified nutritional liquids is administered orally to individuals as a dietary source of omega 3 fatty acids as described herein, including administration in some instances as a sole source of nutrition. Each exemplified liquid formula has improved oxidative stability, especially during prolonged storage. Each formula, even after prolonged storage of from 12 to 24 months, has minimal or no apparent off-odors or flavors associated with the omega-3 fatty acid component.

What is claimed is:

1. A liquid nutritional composition comprising
(A) a protein component;
(B) a carbohydrate component;
(C) a lipid component having from about 0.1% to about 20% of an n-3 polyunsaturated fatty acid by weight of the liquid composition;
(D) from about 0.001% to about 9% by weight of an Ascorbic Acid Component having a Water Soluble Fraction and an Oil Soluble Fraction in a weight ratio of from about 1:20 to about 20:1;
wherein the composition is substantially free of iron and is in the form of an aqueous emulsion having a continuous aqueous phase and at least one discontinuous non-aqueous phase, and wherein the non-aqueous phase comprises non-aqueous particles having a mode of particle size distribution of at least about 0.7 μm and wherein at least about 90% of the non-aqueous particles have a diameter of at least about 0.5 μm.

2. The liquid nutritional composition of claim 1 wherein the mode of particle size distribution is from about 1.0 μm to about 4.0 μm.

3. The liquid nutritional composition of claim 1 wherein the non-aqueous particles have a specific surface area of less than about 80,000 cm² per gram of the non-aqueous particles.

4. The liquid nutritional composition of claim 1 wherein the non-aqueous particles have a specific surface area of from about 10,000 cm² per gram to about 50,000 cm² per gram of the non-aqueous particles.

5. The liquid nutritional composition of claim 1 wherein the weight ratio of the Water Soluble Fraction and an Oil Soluble Fraction is from about 1:5 to about 5:1.

6. The liquid nutritional composition of claim 1 wherein the composition further comprises from about 0.01% to about 5% by weight of a tocopherol.

7. The liquid nutritional composition of claim 5 wherein the tocopherol is selected from the group consisting of alpha tocopherol, gamma tocopherol, beta tocopherol, delta tocopherol, and combinations thereof.

8. The liquid nutritional composition of claim 1 wherein the tocopherol represents from about 0.005% to about 1.0% by weight of the composition.

9. The liquid nutritional composition of claim 1 wherein the total iron concentration in the composition are less than about 0.2 mg per 100 ml of the composition.

10. The liquid nutritional composition of claim 1 wherein the composition is substantially free of unbound copper.

11. The liquid nutritional composition of claim 1 wherein total copper concentration in the composition is less than about 0.3 mg per 100 ml of the composition.

12. The liquid nutritional composition of claim 1 wherein the n-3 polyunsaturated fatty acid comprises from about 20% to 100% EPA.

13. The liquid nutritional composition of claim 1 wherein the n-3 polyunsaturated fatty acid comprises from about 20% to 100% DHA.

14. The liquid nutritional composition of claim 1 wherein the n-3 polyunsaturated fatty acid comprises from about 20% to 100% of a combination of DHA and EPA.

15. The liquid nutritional composition of claim 1 wherein the Water Soluble Fraction is ascorbic acid and the Oil Soluble Fraction is ascorbyl palmitate.

16. A liquid nutritional composition comprising
(A) a protein component representing from about 5% to about 50% of total calories in the composition;
(B) a carbohydrate component representing from about 5% to about 75% of the total calories;
(C) a lipid component representing from about 5% to about 75% of the total calories and including from about 0.1% to about 20% of an n-3 polyunsaturated fatty acid by weight of the liquid composition;
(D) from about 0.001% to about 5% by weight of an Ascorbic Acid Component having a Water Soluble Fraction and an Oil Soluble Fraction in a weight ratio of from about 1:20 to about 20:1; and
(E) from about 0.005% to about 1.0% by weight of a tocopherol;
wherein the composition is substantially free of iron and copper, and wherein the composition is in the form of an aqueous emulsion having a continuous aqueous phase and at least one discontinuous non-aqueous phase, and wherein the non-aqueous phase comprises non-aqueous particles having a mode of particle size distribution of at least about 7.0 μm and wherein at least about 90% of the non-aqueous particles have a diameter of at least about 0.5 μm.

17. The liquid nutritional composition of claim 16 wherein the mode of particle size distribution is from about 1.0 μm to about 4.0 μm.

18. The liquid nutritional composition of claim 16 wherein the mode of particle size distribution is from about 1.3 μm to about 3.7 μm.

19. The liquid nutritional composition of claim 16 wherein the non-aqueous particles have a specific surface area of less than about 80,000 cm² per gram of the non-aqueous particles.

20. The liquid nutritional composition of claim 16 wherein the non-aqueous particles have a specific surface area of from about 10,000 cm² per gram to about 50,000 cm² per gram of the non-aqueous particles.

21. The liquid nutritional composition of claim 16 wherein the weight ratio of the Water Soluble Fraction and an Oil Soluble Fraction is from about 1:5 to about 5:1

22. The liquid nutritional composition of claim 16 wherein the tocopherol is selected from the group consisting of alpha tocopherol, gamma tocopherol, beta tocopherol, alpha tocopherol, and combinations thereof.

23. The liquid nutritional composition of claim 16 wherein the tocopherol represents from about 0.005% to about 0.5% by weight of the composition.

24. The liquid nutritional composition of claim 16 wherein total iron concentration in the composition is less than about 0.2 mg per 100 ml of the composition.

25. The liquid nutritional composition of claim 16 wherein total copper concentration in the composition are less than about 0.05 mg per 100 ml of the composition.

26. The liquid nutritional composition of claim 16 wherein the n-3 polyunsaturated fatty acid comprises from about 20% to 100% EPA.

27. The liquid nutritional composition of claim 16 wherein the n-3 polyunsaturated fatty acid comprises from about 20% to 100% DHA.

28. The liquid nutritional composition of claim 16 wherein the n-3 polyunsaturated fatty acid comprises from about 20% to 100% of a combination of DHA and EPA.
